(19) United States
(12) Patent Application Publication
(10) Pub. No.: US 2006/0038335 A1
(43) Pub. Date: Feb. 23, 2006

(54) Clamp/base fit into a 1/2" hole & 1/2" insertion holding pins

(76) Inventor: William R. Sherman III, Modesto, CA (US)

Correspondence Address: WILLIAM R. SHERMAN, 1136 ROOT RD, MODESTO, CA, 95357, US

(21) Appl. No.: 10/926,648

(22) Filed: Aug. 23, 2004

(51) Int. Cl. B23Q 3/00

(52) U.S. Cl. 269/305

(57) ABSTRACT

Disclosed herein is a small all purpose clamping device, having a structured body made of steel for durability with a ½″ pin protruding from the bottom, to be placed into ½″ holes drilled into most surfaces. The clamp assembly will seize securely long, large or small and/or a shaped workpiece between fencing or molded pins placed in ½″ holes. The clamp assembly will rotate in place, fitting the workpiece. There are no affixed ends or hold downs which enable the clamp to be instantly removed. The clamp assembly is fabricated with a clamping plate attached to ¼″ rods sliding through the body, stabilizing the clamp action, snapping forward against the material being held, leaving free movement for a threaded turning shaft to clamp.

### CROSS-REFERENCE RELATED TO THIS APPLICATION

This Application is entitled to the benefit of the Provisional Patent Application referenced below, by the statutory requirement a reference is made thereto in the application.

The current Provisional Patent Application to-date is Control No. 60/734,436

### FIELD OF THE INVENTION

This invention will (Clamp), seize securely materials into place. Using ½″ Holes drilled into most surfaces.

The present invention relates to the operational system above and is referenced throughout the application as such. A complete background history dating back to more than 20 years usage of a Radial Arm, named after me Sherman, called the Sher-Guide. A system of Operation that utilize the ½″ Hole Clamp in most all of the innovative disclosures that have never been seen, done or manufactured before.

### BACKGROUND OF THE INVENTION

Prior Art of record have found no similarly characterized clamping device related as to the combined uses, design and/or ability of the ½″ Hole Clamp Assembly.

The Clamp as in this disclosure is unique, there are no affixed ends or hold downs in the unit which can be easily removed, portable to be used for many purposes. The clamp will rotate to fit a workpiece and utilized in locations most clamps will not operate. The clamp assembly is small in comparison but can seize securely long, large or small and/or a shape workpiece and with in performance can duplicate the abilities of many clamps. The ½″ Hole Clamp uses are universal in all professions designed for home workshops performing the desired clamping operations of the American Craftsman.

### DETAILED DESCRIPTION OF THE INVENTION

Drawing Specification See (Replacement Drawing Sheet)

The ½″ Hole Clamp Assembly is fabricated with a Base/1, using a ½″ Pin/2, centered and press fit into the bottom. Two ¼″ holes are center drilled 2¼″ apart through the Base/1, with a (+) tolerance. Two ¼″ Rods/3 are press fit 2¼″ apart into a Clamping Plate/4, comprising a Clamping Unit 3 and 4, that will slide smoothly through the Base/1 at all times. A hole is drilled, center/tapped at 30 degrees for ¼″ n/c or c/clamp thread, to allow a Threaded Shaft/7 with an affixed c/clamp end/8 to be turned with a Handle/5 against the Clamping Unit 3 and 4, both of which stabilize and provide the clamping action.

(Note): The Turning Handle/5 can be molded around the hex head shaft/7 eliminating the jamb nut/6.

### DESCRIPTION OF THE DRAWING VIEWS

FIG. 1 Shown in the Parts Section of the Drawing Sheet is an enlarged perspective elevation side view of the ½″ Hole Clamp assembly, provided for clarity as a visual aid, identifying the component parts of the ½″ Hole Clamp Assembly.

FIG. 2 Is a perspective view of the ½″ Hole Clamp assembly from the top, identifying component parts according to the present invention.

FIG. 3 Is a perspective elevation side view of the ½″ Hole Clamp assembly, identifying component parts and the angle of movement used providing the clamping action according to the present invention.

FIG. 4 Is an elevated view from the side of the Molded Insertion Pin, part 9 in the parts list. Including ¾″ Aluminum Angle, utilizing Part 9 as a Fencing Hold Down through ½″ holes.

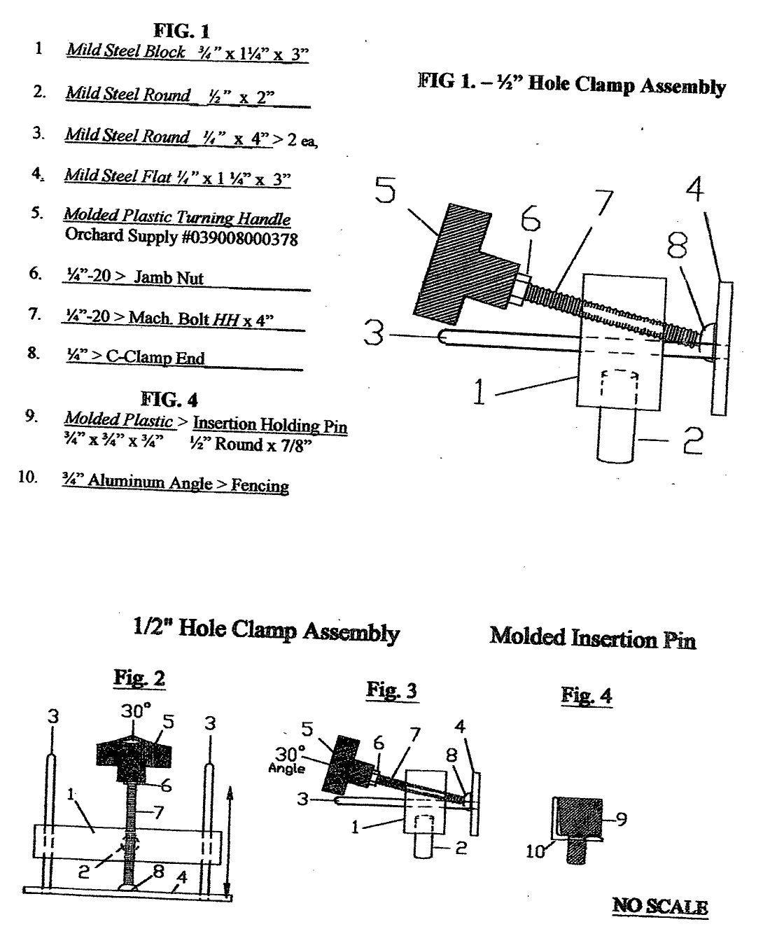

### SUMMARY OF THE INVENTION

This invention is comprised of a clamp assembly that provide a means to secure a workpiece of different configuration and size to surfaces utilizing ½″ holes dilled in straight, further apart, or patterns, between fencing or molded insertion holding pins placed in the arranged ½″ holes. The ½″ Hole Clamp uses are universal seizing tight tight the workpiece, simplifying the multitude of workshop clamping needs in home workshops everywhere.

1. The Clamp Assembly body is fabricated with a ½″ pin press fit into the bottom with two ¼″ holes center drilled at a (+) tolerance spread 2¼″ apart through the side and including a ¼″ hole center taped at 30 degrees of angle through the body.

2. The Clamping Unit is fabricated with two ¼″ rods press fit into the side of a clamping plate spread 2¼″ apart as in claim 1, that comprise a clamping unit.

3. The Turning Handle, fabricated with molded plastic has a 4″ threaded shaft fitted at 30 degrees through the body as in claim 1, with a c/clamp end attached and when is turned against the clamping unit as in claim 2, will seize tight a workpiece.

4. The Clamping Unit as in claim 1 and 2, will slide smoothly through the body holes snapping forward against the workpiece, leaving free movement for the turning handle as in claim 3, to seize tight the workpiece and stabilize the clamping action.

5. The Clamp Assembly as in claim 1, with a ½″ pin protruding from the bottom is inserted into a plurality of holes drilled in triangular, protracted, straight, or further apart patterns that will hold long, large or small or a shaped wotkpiece between fencing or insertion holding pins.

6. The Clamp Assembly as in claims 1,2,3,4, have no affixed ends or hold downs and when inserted in ½″ holes as in claim 5, can be easily and instantly removed.

7. The surface required for the Clamp Assembly can be off cut scraps of wood, flat material, a table top or locations where ½″ holes are drilled as in claim 5 and utilized in the home workshops of every American Craftsman.
